(19) United States
(12) Patent Application Publication
(10) Pub. No.: US 2011/0226077 A1
(43) Pub. Date: Sep. 22, 2011

(54) APPARATUS INCLUDING A GEAR TOOTH SEQUENCE FOR USE IN A VARIABLE TRANSMISSION

(75) Inventors: Nimrod Eitan, Tel Aviv (IL); Joseph Etzion, Yehud (IL)

(73) Assignee: IQWIND LTD., Bazra (IL)

(21) Appl. No.: 12/670,644

(22) PCT Filed: Dec. 10, 2009
(86) PCT No.: PCT/IB2009/055670

§ 371 Date: Jan. 26, 2010

Related U.S. Application Data
(60) Provisional application No. 61/121,559, filed on Dec. 11, 2008.

(30) Foreign Application Priority Data
Oct. 1, 2009 (IB) PCT/IB2009/054299

(51) Int. Cl. F16H 55/17

(52) U.S. Cl. 74/457

(57) ABSTRACT

Apparatus for use in a variable ratio transmission has gear teeth (12) formed for engaging a facing gear wheel, each having a plane of symmetry (P) parallel to a width of the tooth. Links (30) rigidly associated with the gear teeth are sequentially interconnected to form hinge joints (32) between adjacent pairs of gear teeth, thereby forming a gear tooth sequence (11). The hinge joint (32) for each pair of adjacent gear teeth has an axis of rotation (34) lying on a plane (B) bisecting an angle between the planes of symmetry (B) of the adjacent gear teeth.

### FIELD AND BACKGROUND OF THE INVENTION

The present invention relates to gears for variable transmissions and, in particular, it concerns an apparatus including a gear tooth sequence for use in a variable transmission.

Various attempts have been made to design a gear wheel which would provide a variable diameter and variable effective number of teeth. Particularly for bicycles, many designs have been proposed in which segments of a gear wheel can be moved radially outwards so that the segments approximate to rounded corners of a toothed polygon with variable spaces therebetween. These designs can engage a chain and have a variable effective number of teeth where the spaces correspond to “missing” teeth. Examples of such designs may be found in U.S. Pat. Nos. 2,782,649 and 4,634,406, and in PCT Patent Application Publication No. WO 83/02925. This approach generates a non-circular effective gear which has missing teeth between the gear wheel segments. As a result, it is clearly incompatible with direct engagement between gearwheels. Even when used with a chain, the rotating polygonal shape may be expected to cause instability and vibration if used at significant speeds, and does not provide uniform power transfer during rotation.

A further variant of the aforementioned approach is presented in German Patent Application Publication No. DE 10016698 A1. In this case, sprocket teeth are provided as part of a flexible chain which is wrapped around a structure of radially displaceable segments. The chain is anchored, to one of the displaceable segments and a variable excess length at the other end of the chain is spring-biased to a recoiled storage state within an inner volume of the device.

Reference is made to co-pending co-assigned US Patent Application Publication No. 2009/0018043 (application Ser. No. 12/204,027, hereafter “the '043 application”), which was unpublished as of the filing date of the provisional application from which priority is being claimed for this application, and is not admitted prior art except where and to the extent that applicable law deems it so. The '043 application describes a variable transmission system in which sequences of gear teeth are deployed on circles of varying diameters while maintaining a constant pitch between adjacent teeth. Typically, two such sequences of gear teeth are used in combination to provide an effective cylindrical gear with a variable number of teeth.

Reference is also made to PCT Patent Application No. PCT/IB09/054,299 (hereafter “the '299 application”) which was filed after the filing date of the provisional application from which priority is being claimed for this application, and is not prior art. The '299 application describes additional implementations of the variable transmission system of the '043 application, particularly relating to an adjustment mechanism for changing the diameter of the variable diameter gear while maintaining deployment of the gear teeth on a circular profile.

The '043 application and the '299 application provide the preferred context in which the present invention will be described. The '043 application and the '299 application are hereby incorporated herein by reference in their entirety. Unless otherwise stated herein, definitions of the terminology used in this document, and additional technical details of the structure of the present invention and its range of applications, are as detailed in these applications.

In order to maintain a constant pitch between adjacent teeth in the variable diameter gear, the various proposed structures in the '043 application employ a tooth sequence linkage, also referred to as a tooth chain, as illustrated in FIGS. 9A and 9B. In these structures, a pin 10 aligned with each gear tooth 12 serves as a pivot axis between adjacent links 14 of the structure. In FIG. 9A the structure is shown with the wedge-shaped base blocks 12a of the teeth fully closed together, corresponding to a minimum diameter state of the variable diameter gear, while FIG. 9B shows a lower curvature arrangement corresponding to a larger diameter state. Links 14 maintain a constant linear pitch between adjacent teeth.

In order to optimize the function of the variable diameter gear over its range of operating diameters, it is believed to be advantageous to maintain the circular pitch, i.e., the distance between adjacent gear teeth as measured around the pitch circle, as near constant as possible. In the case of the links illustrated in FIGS. 11A and 11B, the constant linear pitch translates into a reduced circular pitch with increased diameter.

A further challenge of certain implementations of a variable diameter gear according to the aforementioned applications is to maintain accurate radial alignment of the individual gear teeth, despite the pivotal interconnection of the teeth in the tooth sequence linkage.

It would therefore be advantageous to provide a mechanical linkage which may be used to implement the gear teeth sequences in an implementation of the principles taught in the aforementioned applications, and which would provide an enhanced approximation to a constant circular pitch between teeth and/or would provide for enhanced radial alignment of teeth in the gear tooth sequence.

### SUMMARY OF THE INVENTION

The present invention is an apparatus including a gear tooth sequence for use in a variable transmission.

According to an embodiment of the present invention there is provided, apparatus for use in a variable ratio transmission, the apparatus comprising: (a) a plurality of gear teeth formed for engaging a facing gear wheel, each of the teeth having a plane of symmetry parallel to a width of the tooth; and (b) a plurality of links, each of the links being rigidly associated with a corresponding one of the gear teeth, the links being sequentially interconnected so as to form hinge joints between adjacent pairs of the plurality of gear teeth, thereby forming a gear tooth sequence, wherein the hinge joint for each pair of adjacent gear teeth has an axis of rotation lying on a plane bisecting an angle between the planes of symmetry of the adjacent gear teeth.

According to a further feature of an embodiment of the present invention, the plurality of gear teeth correspond substantially to teeth of an involute gear of given pitch diameter D, and wherein, when the gear teeth are arranged such that the gear tooth sequence approximates to a part of the involute gear of pitch diameter D, the hinge joint for each pair of adjacent gear teeth has an axis of rotation located within one percent of the pitch diameter from a corresponding pitch circle.

According to a further feature of an embodiment of the present invention, the gear tooth sequence is configured such that, in a minimum diameter state, the gear tooth sequence provides a complete effective gear of pitch diameter D.

According to a further feature of an embodiment of the present invention, each of the gear teeth is rigidly associated with two of the links, the links being deployed on opposing sides of the corresponding gear tooth.

According to a further feature of an embodiment of the present invention, there is also provided an adjustable support, wherein the gear tooth sequence in engaged by the adjustable support so as to assume a sequence of states including: (a) a minimum diameter state in which the gear tooth sequence approximates to a part of a gear wheel of pitch radius R₁ and angular pitch between teeth τ₁; and (b) a maximum diameter state in which the gear tooth sequence approximates to a part of a gear wheel of pitch radius R₂ and angular pitch between teeth τ₂, wherein a circular pitch between the gear teeth in the maximum diameter state is substantially equal to the circular pitch between the gear teeth in the minimum diameter state.

According to a further feature of an embodiment of the present invention, the hinge joint for each pair of adjacent teeth is displaced from the pitch circle by an adjustment displacement h defined by:

$$h = \frac{{R}_{1} {τ}_{1}}{24} ( 2 {τ}_{2} - {τ}_{1} ) .$$

According to a further feature of an embodiment of the present invention, there is also provided: (a) a central axle; and (b) a plurality of radial alignment brackets, each of the radial alignment brackets being rigidly interconnected with one of the gear teeth, and being engaged with the central axle so as to allow rotation of the radial alignment bracket about the axle and variation of a radial distance of the gear tooth from the axle.

### BRIEF DESCRIPTION OF THE DRAWINGS

The invention is herein described, by way of example only, with reference to the accompanying drawings, wherein:

FIG. 1 is an overall isometric view of an embodiment of a variable diameter gear device, constructed and operative according to the teachings of the present invention, including two gear tooth sequences which provide a variable diameter effective cylindrical gear engaged with an idler gear arrangement as part of a variable ratio transmission system.

FIG. 2 is an isometric view of one gear tooth sequence and an associated disc with a spiral track, forming part of an adjustable support, from the gear device of FIG. 1.

FIGS. 3A-3C are axial views of the gear tooth sequence and disc of FIG. 2, shown in a minimum, intermediate and maximum diameter state, respectively.

FIGS. 4A and 4B are isometric illustrations of part of the gear tooth sequence of FIG. 2 showing details of tooth-centered links making up the gear tooth sequence, the gear tooth sequence being shown in a minimum diameter and an enlarged diameter state, respectively.

FIGS. 5A and 5B are side views of the part of the gear tooth sequence as illustrated in FIGS. 4A and 4B, respectively.

FIGS. 6A and 6B are diagrams illustrating certain terminology as used in the non-limiting theoretical analysis presented below.

FIG. 7 is a graph illustrating the variation in circular pitch between implementations of a variable gear employing gear tooth sequences formed with tooth-aligned-hinges and formed with tooth-centered links, with and without an additional radial hinge position correction.

FIG. 8 is an isometric view of the gear tooth sequence of FIG. 2 additionally showing a set of radial aligners deployed to maintain radial alignment of gear teeth of the variable diameter gear.

FIGS. 9A and 9B are enlarged isometric views showing a single radial aligner from the structure of FIG. 8 in a minimum radius and maximum radius state, respectively.

FIGS. 10A and 10B are side views of the structure of FIG. 8 shown in a minimum diameter state and enlarged state, respectively.

FIGS. 11A and 118, described above, are isometric illustrations of part of a gear tooth sequence according to the teachings of the '043 and '299 applications, shown in a minimum diameter and an enlarged diameter state, respectively.

### DESCRIPTION OF THE PREFERRED EMBODIMENTS

The present invention is an apparatus including a gear tooth sequence for use in a variable transmission.

The principles and operation of an apparatus according to the present invention may be better understood with reference to the drawings and the accompanying description.

### Variable Transmission System

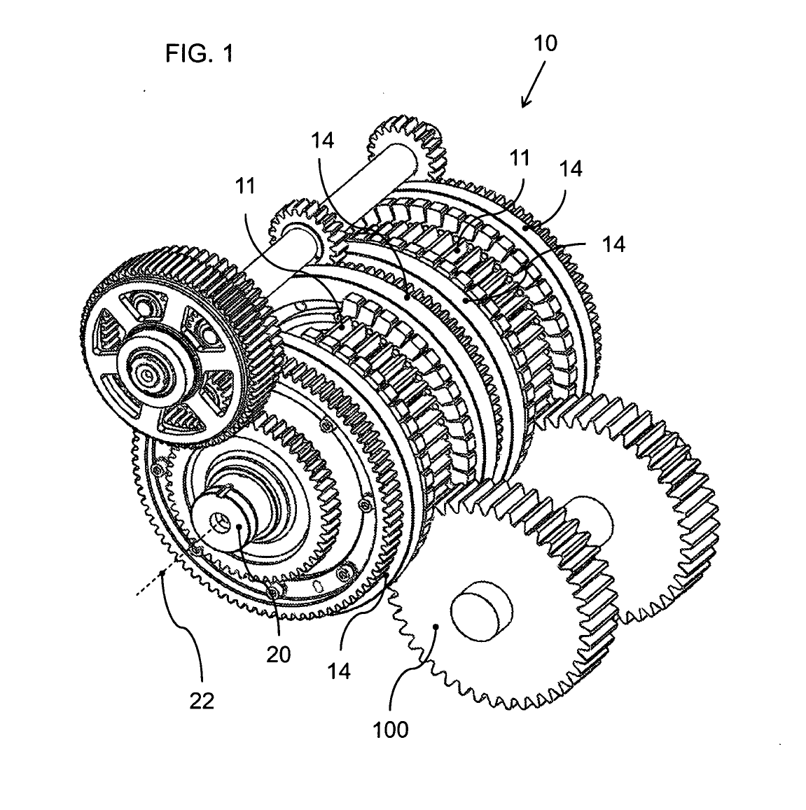

Referring now to the drawings, FIG. 1 shows an overall isometric view of the main parts of a variable transmission system including a variable gear device 10 engaged with an idler gear arrangement 100. Variable gear device 10 operates according to the principles described in the above-referenced '043 and '299 applications, and corresponds to the preferred context in which the apparatus of the present invention will be described, as well as a preferred embodiment of a variable transmission system according to the teachings of the present invention.

The structure and operation of the variable transmission system of FIG. 1 are described at length in the above-referenced '043 and '299 applications, and will be described here only briefly, to the extent necessary for a clear and self-contained description of embodiments of the present invention.

Generally speaking, variable gear device 10 has an axle 20 defining an axis of rotation 22. A gear tooth set includes at least one, and in this case two, displaceable gear tooth sequences 11, each formed from a plurality of interconnected gear teeth 12 lying on a virtual cylinder coaxial with axle 20.

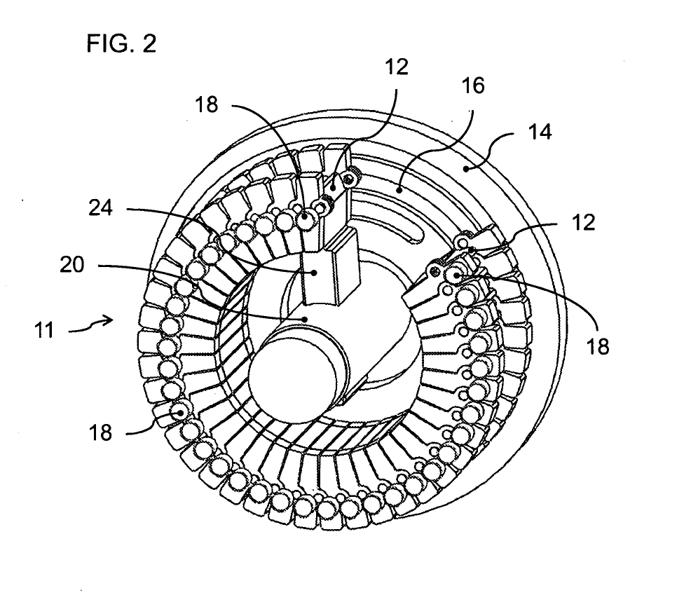

As best seen in FIG. 2, a torque linkage is mechanically linked to axle 20 and to gear tooth sequence 11 so as to transfer a turning moment between the axle and the gear tooth set. In the preferred example illustrated here, the torque linkage is formed by a radially displaceable shaft 24, attached to or integrally formed with a given tooth 12, referred to as the “alpha” tooth. Shaft 24 passes through a corresponding slot in axle 20, typically via a linear bearing (not shown).

As also best seen in FIG. 2, the variable gear device illustrated here includes a diameter changer which includes at least one disc 14 having a spiral track 16. Each gear tooth 12 is mechanically linked to spiral track 16 such that rotation of disc 14 relative to axle 12 causes variation of an effective diameter of the virtual cylinder while maintaining the virtual cylinder centered on the axis of rotation and while the uniform pitch remains constant.

According to a preferred but non-limiting embodiment of the invention illustrated here, the diameter changer includes a pair of discs 14 deployed on opposite sides of each gear tooth sequence 11, and each gear tooth 12 is mechanically linked to the spiral track of both of the pair of discs. This provides stable and symmetrical support to define the radial position of each tooth. In the view of FIG. 2, the disc closer to the viewer has been removed for clarity of presentation.

According to a preferred but non-limiting embodiment of the invention illustrated here, the spiral track is implemented as a spiral slot 16, which may be a through-slot or may be formed on only one face of disc 14. When the track is implemented as a slot, each gear tooth 12 preferably has an associated projection, such as a pin 18, which engages and slides within spiral slot 16. Each pin 18 typically has a unique offset, i.e., radial position relative to the geometrical center of the corresponding tooth 12. Thus, for example, looking at FIG. 2, pin 18 for the alpha tooth is at the maximum radially inward offset while the tooth at the other end of the tooth sequence has the maximum radially outward offset. This corresponds to the portion of the spiral slot with which each tooth is engaged in order to maintain the gear teeth on a virtual cylinder.

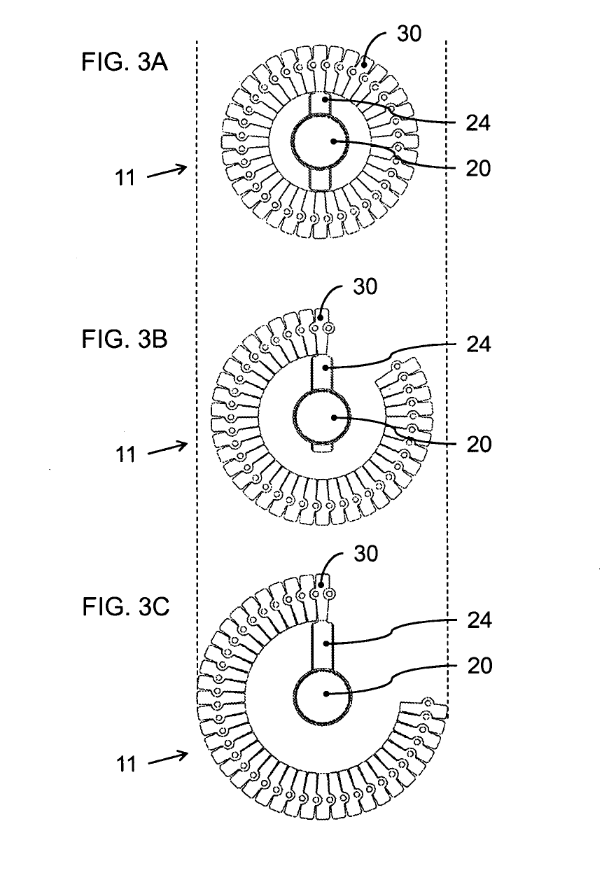

It should be noted that the mechanism of the diameter changer described here is a non-limiting preferred example, and that any mechanism which changes the diameter of gear tooth sequence 11 while maintaining circular geometry may be used. Any and all such mechanisms which support gear tooth sequence 11 in a circular arc while allowing adjustment of the diameter of curvature, and which provide torque linkage to and/or from the gear tooth sequence, are referred to generically herein as an “adjustable support”. Other examples include various arrangements of smooth cones and ridged cones moving axially, and other arrangements of slotted discs or the like, as will be clear to one ordinarily skilled in the art. Additional details of these implementations are further detailed in the '046 application. The overall effect of actuation of the diameter changer is illustrated in FIGS. 3A-3C which show the change in effective diameter of a single gear tooth sequence 11 while the axle and the alpha tooth are kept at a constant angular position (12 o'clock). The dashed lines represents the maximum diameter for comparison. For simplicity of presentation, discs 14 and pins 18 have been omitted from this and the subsequent drawings.

### Gear Tooth Sequence

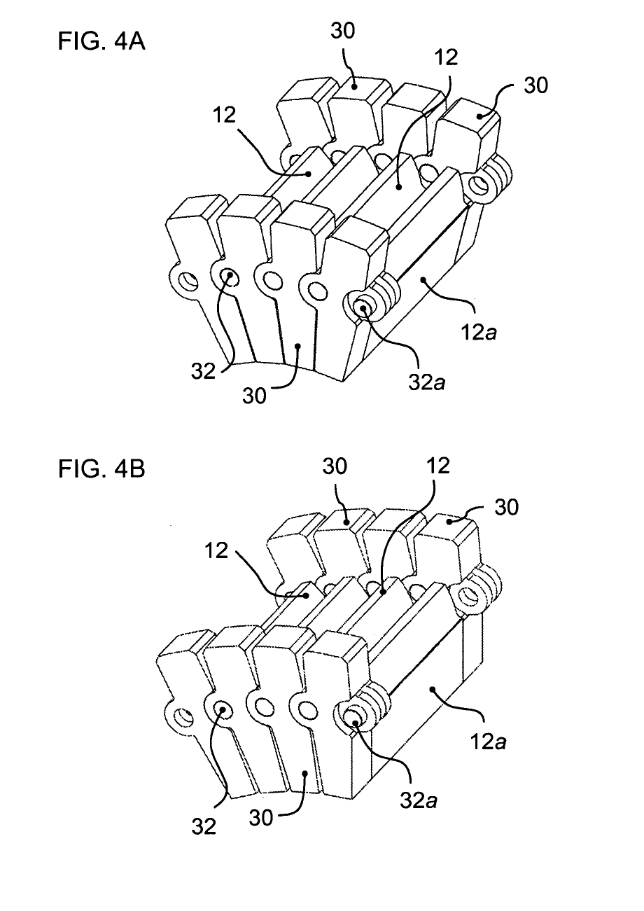

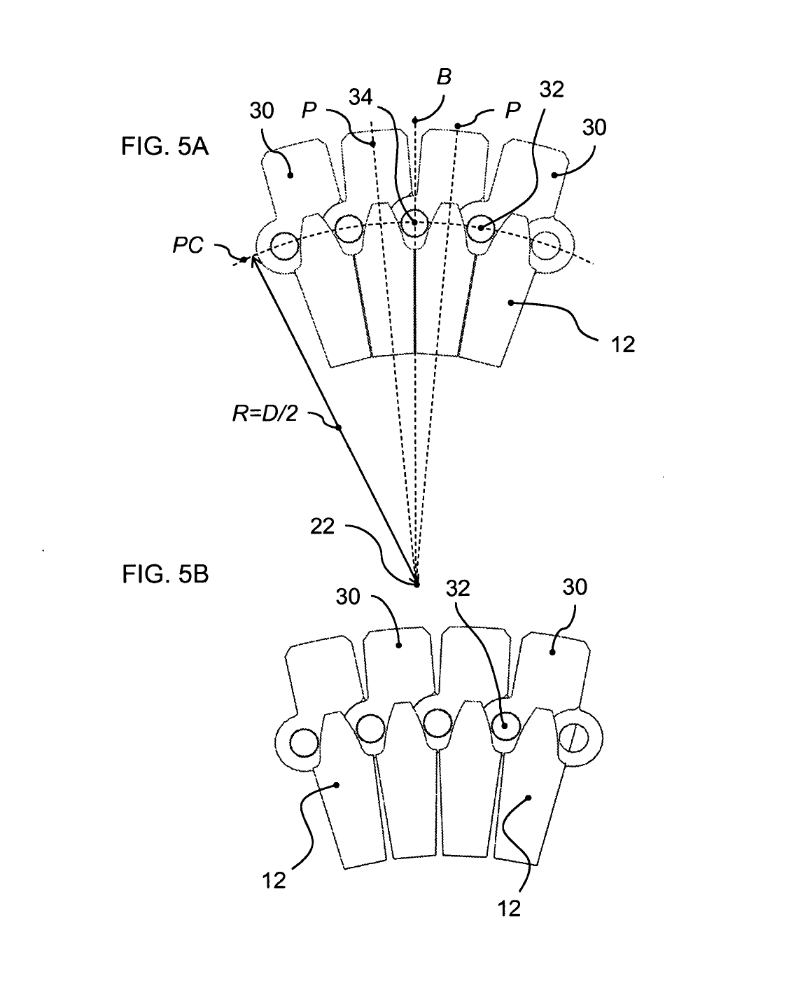

A preferred but non-limiting embodiment of gear tooth sequence 11, constructed and operative according to an aspect of the present invention, is illustrated in FIG. 2, and an enlarged section thereof is shown in FIGS. 4A-5B. Generally speaking, gear tooth sequence 11 includes a plurality of gear teeth 12 formed for engaging a facing gear wheel, such as idler gear arrangement 100 shown above. Each gear tooth 12 has a plane of symmetry P parallel to a width of the tooth, as illustrated in FIG. 5A. A plurality of links 30 are rigidly associated with corresponding gear teeth, typically with two links 30 per gear tooth 12, deployed on opposing sides of each gear tooth. Links 30 are sequentially interconnected so as to form hinge joints 32 between adjacent pairs of gear teeth 12, thereby forming gear tooth sequence 11.

Referring particularly to FIG. 5A, is it a particularly preferred feature of an embodiment of the present invention that hinge joint 32 for each pair of adjacent gear teeth 12 has an axis of rotation lying on a plane B bisecting an angle between planes of symmetry P of the adjacent gear teeth. In other words, each link 30 defines part of two hinge joints deployed symmetrically on opposite sides of each tooth 12.

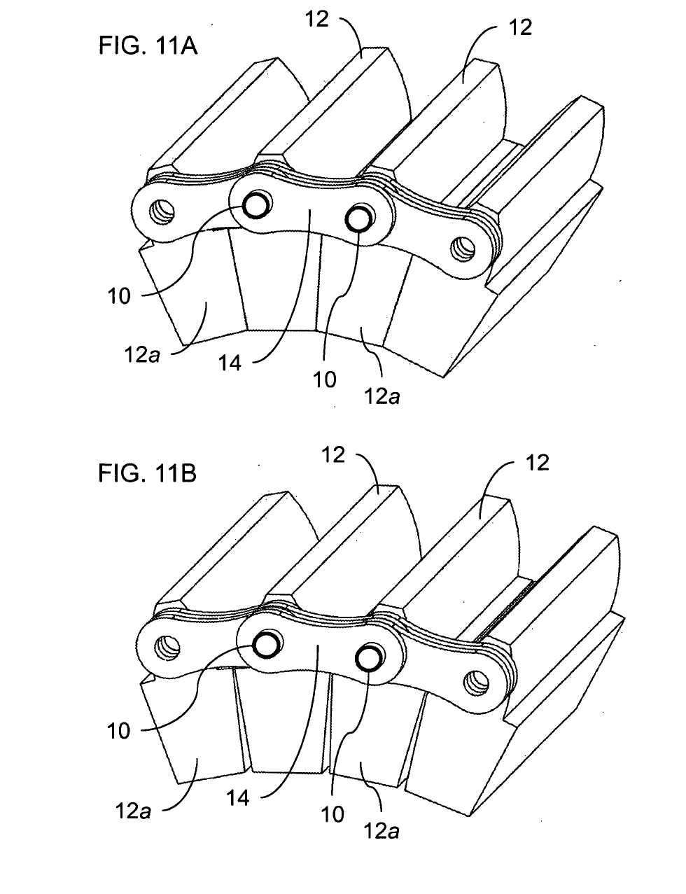

The positioning of the hinge axes of gear tooth sequence 11 so that they are midway between adjacent teeth 12 is believed to provide various advantages. Firstly, this arrangement changes the geometrical properties of the gear tooth sequence, rendering it possible to achieve a closer approximation to constant circumferential pitch than would be possible with linkage of FIG. 11A. A detailed treatment of the geometrical properties, and a specific non-limiting example, are presented in the Theoretical Analysis section, below.

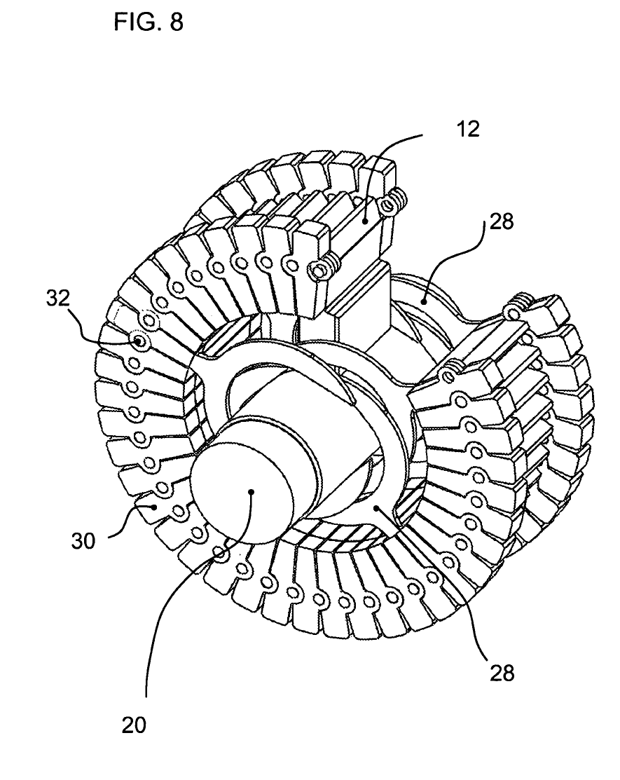

This positioning of the hinge axes is also believed to provide enhanced stability of each gear tooth with respect to radial alignment. Specifically, in order for a tooth to tilt out of alignment relative to the radius from the central axis 22, both adjacent links would also need to be misaligned, one upwards and one downwards. This interdependence of radial alignment between adjacent links renders the entire structure more stable, and allows radial alignment to be preserved by the use of an alignment arrangement engaging intermittent links in the structure, as will be described below with reference to FIGS. 8-10B. These and other advantages of the present invention will become clearer from the following description.

At this point, before addressing features of the present invention in more detail, it will be useful to define certain terminology as used in this description and the accompanying claims. Firstly, the term “gear tooth” is used herein to refer to forms of teeth suitable for meshing in driving relation with teeth of a facing gear, including spur gear and helical gear teeth. A range of different tooth profiles may be used. In most cases, the teeth of the present invention approximate to teeth of an involute spur gear corresponding to the smallest diameter state of the variable diameter gear. Most preferably, the number of teeth 12 in gear tooth sequence 11 corresponds to the full number of teeth in a conventional involute gear of diameter equal to the smallest diameter state of the variable diameter gear, such that each gear tooth sequence 11 forms a complete effective gear in its fully closed state, as illustrated in FIG. 3A.

Terminology used herein for gear geometry is generally used in its accepted sense. In some cases, terms are most easily defined in relation to a pair of gears that are fully meshed and the line of action (or pressure line) along which the force of engagement between the gears is directed. Thus, the “pitch point” is the point where the line of action between two fully meshed gears intersects a line joining the central axes of the two gears, the “pitch radius” is the distance from the axis of rotation to the pitch point, and the “pitch circle” is a circle centered on the axis of rotation passing through the pitch point. It will be noted, however, that the pitch circle is a well defined parameter for a single gear wheel based on the engagement geometry for which it is designed, independent of the parameters of a gear with which it is engaged, as will be clear to one ordinarily skilled in the art. In fact, the pitch diameter (twice the pitch radius) divided by the number of teeth generates the module of the gear, which is a defining feature of the tooth size.

In the context of the present invention, the use of some of this terminology must be further clarified, given that the effective diameter of the gear tooth sequence varies. For the purpose of this disclosure, reference will be made to a “geometrical center” of each tooth defined in relation to the “original pitch circle”. A “current pitch circle” will then be defined as the circle passing through the geometrical centers of the teeth in the current state of the variable gear. Thus, the “original pitch circle” is defined by the pitch diameter corresponding to the equivalent number of teeth and module according to which the teeth were designed, typically corresponding to the smallest diameter state of the gear, as mentioned above. For each gear tooth, the geometrical center of the tooth (in cross-section) is then taken to be the point at which the original pitch circle intersects the center line of the tooth (corresponding to a plane of symmetry parallel to the width of the tooth) when the gear is in its original design state. For each different diameter state of the gear tooth sequence, the “current pitch circle” is then the circle which intersects the geometrical centers of the teeth.

All of these geometrical terms are defined in a plane perpendicular to the axis of rotation, and are typically invariant along the width of the gear teeth.

The “circular pitch” between adjacent teeth is the distance measured along the current pitch circle between geometrical centers of adjacent teeth. This contrasts to the “linear pitch”, which is the straight line distance between the geometrical centers of the teeth. The “angular pitch” is the angle subtended by the geometrical centers of two adjacent teeth at the center of rotation.

Having defined this terminology, when reference is made to the circular pitch being substantially equal between two states of the gear tooth sequence, this should be taken to mean that any variation between the circular pitch values for the two states is less than half the difference in circular pitch which would occur if the linear pitch were kept constant.

Reference is made to an “effective number of teeth” of gear device 10 in each state. The effective number of teeth in any given state is taken to be the current pitch circle divided by the modulus, and typically corresponds to 2π divided by the angular pitch in radians between adjacent teeth about the axis of rotation. In intuitive terms, the effective number of teeth corresponds to the number of teeth that would be in a simple gear wheel which would function similarly to the current state of gear device 10. Where two or more tooth sequences are used with their gear teeth aligned in-phase with each other, the effective number of teeth is simply the number of teeth of the combined gear tooth set as projected along the axis.

Where two or more gear tooth sequences are used, reference may be made to a “degree of peripheral coextension” between the gear tooth sequences. The degree of peripheral coextension corresponds to the angular extent of coextension of the gear tooth sequences around the periphery of the effective cylindrical gear, independent of the current diameter of the cylinder. When reference is made to a variable degree of peripheral coextension, this includes the possibility of the coextension being reduced to zero, i.e., where one tooth sequence provides one tooth and another provides the next tooth without any overlap therebetween. In certain particularly preferred embodiments, the maximum diameter state of each tooth sequence extends around more than half the periphery of the virtual cylinder. In this case, the peripheral coextension of the tooth sequences is preferably greater than zero.

Reference is made to an “effective cylindrical gear” to refer to a structure which is capable of providing continuous toothed engagement with a simple or compound cylindrical idler gear. The individual gear sequences of the present invention typically have spaces in them, as illustrated in FIGS. 1 and 2. However, when two such gear tooth sequences are used together as illustrated in FIG. 1, they allow continuous engagement around the entire revolution of the gear device. It will be noted that the present invention may be used to advantage in transmissions based on directly engaged gear wheels and in chain-based transmissions. In all cases, it may be helpful to refer to an idler gear as a theoretical construct which may be used to define the geometrical properties of gear device 10.

An “idler gear arrangement” in this context is any gear configured for toothed engagement with gear device 10. The term “idler gear arrangement” is used to reflect a typical arrangement in which an idler gear arrangement is an intermediate component in a gear train, but without excluding the possibility of the “idler gear arrangement” being directly connected to a power input or power output axle. The idler gear arrangement is typically a compound idler gear in which two or more gear wheels are mounted so as to rotate together with a common idler axle, such as is illustrated in FIG. 1. The gear wheels making up a compound idler gear are typically identical and in-phase (i.e., with their teeth aligned), but may be implemented as out-of-phase (non-aligned teeth) gear wheels if a corresponding phase difference is implemented between the tooth sequences.

Turning now to the structure of gear tooth sequence 11 in more detail, as best seen in FIGS. 4A and 4B, each gear tooth 12 and its associated links 30 preferably functions as a monolithic gear tooth unit. The gear tooth unit may be integrally formed as a single block. In many cases, however, it may be easier to achieve the desired level of precision for the gear tooth surfaces by forming the gear teeth (portion 12 and block 12a) as an integral unit and subsequently attaching links 30. Attachment may be achieved by any suitable technique, and is typically achieved by use of an arrangement of bolts (not shown).

As mentioned earlier, the form of the teeth preferably employs involute surfaces, and may be implemented as a standard involute gear tooth form. In such cases, the tooth form used typically corresponds to the minimum diameter state of the variable diameter gear tooth sequence. Thus for example, in the gear tooth sequence illustrated here, the minimum diameter state (FIG. 3A) corresponds to a 36 tooth gear while the maximum diameter (FIG. 3C) corresponds to a 44 tooth gear. In this case, the gear tooth form may be chosen to correspond to teeth of a standard 36 tooth involute gear.

Most preferably, the wedge shape of block 12a is also chosen to correspond substantially to the angular pitch of the minimum diameter state so that the blocks substantially abut in the minimum diameter state. The fully closed state thus closely resembles a conventional solid gear wheel of similar dimensions.

Hinge joints 32 may be any structure which defines a hinge or pivot axis between adjacent links 30, allowing some degree of relative rotation about that axis. Clearly, the range of angular motion required is typically small. The structure may include a hinge pin integrated with one of the links, or a separately inserted hinge pin retained by any suitable retention arrangement, as is known in hinged power drive components. In the example illustrated here, a separate hinge pin 32a is inserted through hinge joint openings in links 30. It should be noted that alternative hinge structures without any hinge pin may also be used.

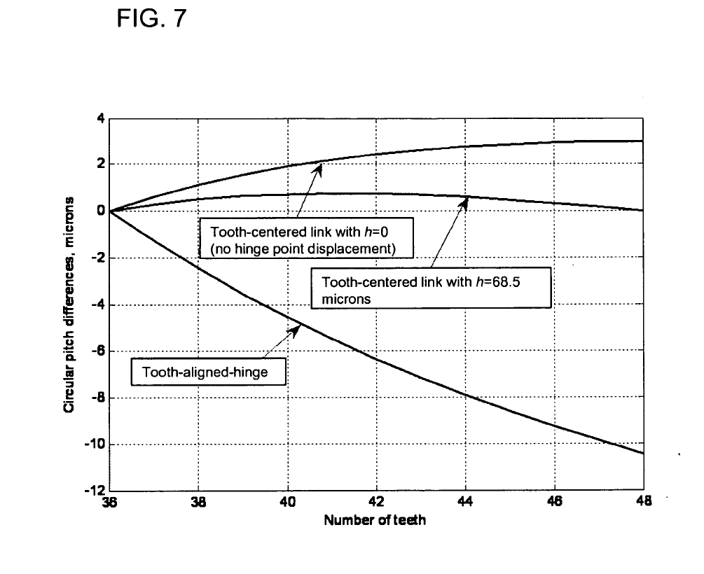

Referring particularly to FIG. 5A, the position of hinge joints 32 is preferably chosen such that, when the gear teeth are arranged on their original pitch circle PC, i.e., corresponding to the diameter for which the tooth form was derived, hinge joint 32 for each pair of adjacent gear teeth has an axis of rotation 34 located on or close to (within one percent of the pitch diameter 1) from) the corresponding pitch circle PC. As will be discussed below with reference to FIG. 7, location of hinge axis 34 exactly on the pitch circle is a very acceptable exemplary implementation of an embodiment of the present invention. However, a further improved approximation for maintaining constant circular pitch between teeth may be achieved by employing a small radial displacement from the pitch circle. In one particularly preferred example, this adjustment displacement h is defined by:

$$h = \frac{{R}_{1} {τ}_{1}}{24} ( 2 {τ}_{2} - {τ}_{1} )$$

where R₁ is the pitch radius for a minimum diameter state of gear tooth sequence 11; τ₁ is the angular pitch between teeth for a minimum diameter state of gear tooth sequence 11; and τ₂ is the angular pitch between teeth for a maximum diameter state of gear tooth sequence 11.

### Theoretical Analysis

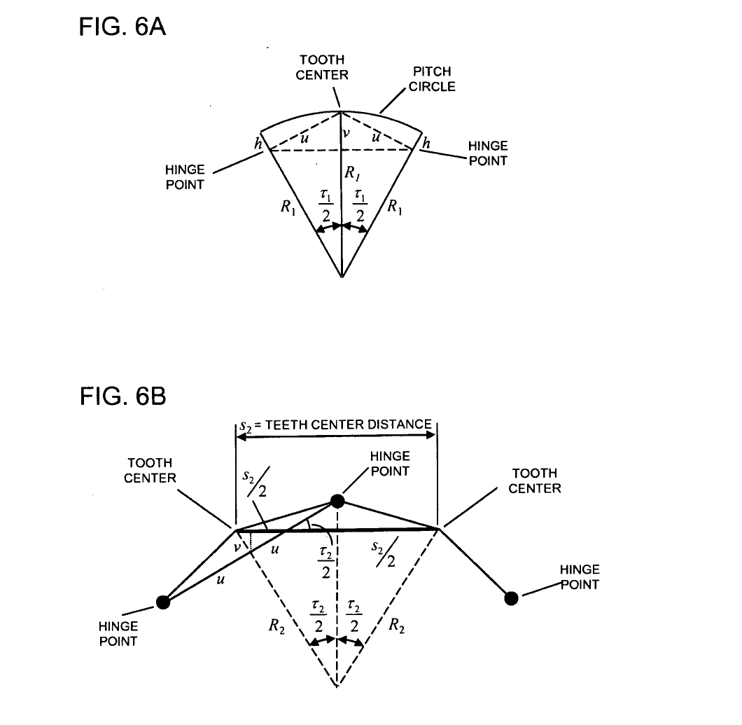

Referring now to FIGS. 6A-7, a theoretical analysis and practical example of the reduction in variation of the circular pitch according to an embodiment of the present invention will be addressed. It should be noted that this analysis is provided to facilitate understanding, but should not be considered to limit the scope of the present invention, which may be implemented in numerous alternative ways. The particular values mentioned as an example below may be regarded as indicative of a particularly preferred example, but are also non-limiting with regard to the general scope of the present invention.

This analysis relates to two linkage geometries to assess how the circular pitch varies for each as a function of the effective number of teeth. These two geometries are:
A tooth-aligned-hinge link design, where the hinged connection between links is aligned with the center of the tooth as shown in FIGS. 11A and 11B.
A tooth-centered link design, where the link's center connects it to the tooth center, while the sides provide hinging points with the neighboring links, as shown in FIGS. 4A-5B.

In a tooth-aligned-hinge link, the chord, which is the linear distance between adjacent teeth, is constant, which means that in a variable-diameter gear the circular pitch varies as a result of the diameter change: the greater the diameter, the smaller becomes the circular pitch. In a tooth-centered link, in contrast, as a result of the diameter increase there is also a slight increase of the linear distance between adjacent teeth, which diminishes to a great extent the circular-pitch variation that occurs in the tooth-aligned-hinge geometry.

The exact geometry of a tooth-centered link is determined for a gear wheel with a given number of teeth, z₁, and a given module, giving a certain pitch radius, R₁. The characteristic geometric parameters of a tooth-centered link are shown in FIG. 6A.

In this basic geometry, all the tooth centers are located on the same pitch circle of radius R₁. The hinging points are located at exactly a half-way between the angular teeth locations. The pitch angle, τ₁, is in this case given by

τ₁=2π/z₁. (1)

For later calculations of a variable diameter we shall need the values of the parameters u and v, shown in FIG. 6A. These parameters are given by

$$u = ( {R}_{1} - h ) sin \frac{{τ}_{1}}{2} , \\ v = {R}_{1} - ( {R}_{1} - h ) cos \frac{{τ}_{1}}{2} , \qquad ( 2 )$$

where h is a given displacement of the hinge point from the pitch circle.

The pitch radius, R₁, is given by

R₁=mz₁/2, (3)

where m is the module.

Suppose now that the number of teeth in the gear has been changed to z₂, with a new pitch radius R₂. In the new gear, the linear distance between adjacent teeth is determined by the geometry shown in FIG. 6B.

In the new gear, the pitch angle is given by

τ₂=2π/z₂. (4)

And, according to the geometry in FIG. 611, the linear distance between tooth centers is

$${s}_{2} = 2 ( u cos \frac{{τ}_{2}}{2} + v sin \frac{{τ}_{2}}{2} ) , \qquad ( 5 )$$

where u and v are given by Equations 2.

It can be verified that in the original gear, with the number of teeth equal to z₁, Equation 5 reduces to s₁=2u, as it should be (compare with FIG. 6A). This result is obtained by substituting τ₁ instead of τ₂ in Equation 5, in addition to the substitution of the explicit expressions of u and v from Equations 2.

According to FIG. 6B, the pitch radius in the modified gear, R₂, is given by

$${R}_{2} = \frac{{s}_{2}}{2 sin ( {τ}_{2} / 2 )} \qquad ( 6 )$$

and the circular pitch of the two gears is given by

$$\begin{matrix}{p}_{1} = {R}_{1} {τ}_{1} \\ and & ( 7 ) \\ {p}_{2} = {R}_{2} {τ}_{2} = \frac{{s}_{2} {τ}_{2}}{2 sin ( {τ}_{2} / 2 )} . & ( 8 )\end{matrix}$$

It will be noted that h is a design parameter which can be varied in order to further minimize the variations in circular pitch. For the purpose of this analysis, an “optimal” value of the hinge displacement, h (FIG. 6A), is taken to be a value which equates the circular pitches of the two gear sizes, z₁ and z₂ The equality requirement states that

p₁=p₂, (9)

where p₁ and p₂ are the corresponding circular pitches in gears with z₁ and z₂ teeth, respectively.

By using the explicit Equations 7 and 8 for the two circular pitches, Equation 9 becomes

$${R}_{1} {τ}_{1} = \frac{{s}_{2} {τ}_{2}}{2 sin ( {τ}_{2} / 2 )} , \qquad ( 10 )$$

where s₂ is given by Equation 5.

Notice that s₂ depends on the displacement, h, via u and v, which are functions of h, as given by Equations 2. Hence, by substituting Equations 2 in Equation 5, and then substituting the resulting expression of s₂ in Equation 10, we get a single equation which is linearly dependent on h. This linear equation provides the following solution of the necessary displacement:

$$h = ( 1 - \frac{( \frac{{τ}_{1}}{{τ}_{2}} - 1 ) sin \frac{{τ}_{2}}{2}}{sin \frac{{τ}_{1} - {τ}_{2}}{2}} ) {R}_{1} , \qquad ( 11 )$$

where R₁ is the pitch radius of the first gear (Equation 3), and τ₁ and τ₂ are the pitch angles of the two gears (Equations 1 and 4).

Since τ₁ and τ₂ are very small angles, the sines in Equation 11 can be expanded into a power series, retaining only the first two terms of the series and ignoring the rest. As a result of such expansion, Equation 11 is reduced to the following simple approximation:

$$h = \frac{{R}_{1} {τ}_{1}}{24} ( 2 {τ}_{2} - {τ}_{1} ) . \qquad ( 12 )$$

Equation 12 provides results practically identical to those of Equation 11.

Clearly, an optimal displacement, h, can be determined by equrting the circular pitches of any two selected gear sizes, z₁ and z_{z}. For other gear sizes, different from either z₁ or z₂, the resulting circular pitch (for the given h) will differ slightly from the original circular pitch, p₁. For a given number of teeth, zᵢ, the resulting circular pitch, pᵢ, can be calculated by an equation similar to Equation 8:

$${p}_{i} = \frac{{s}_{i} {τ}_{i}}{2 sin ( {τ}_{i} / 2 )} , \qquad ( 13 )$$

where τᵢ is the pitch angle and sᵢ is the corresponding distance between the tooth centers, both calculated by equations similar to Equations 4 and 5.

As said before, there will be a slight difference between the resulting circular pitch, pᵢ, and the original pitch, p₁. This difference is given by

Δpᵢ=pᵢ−p₁. (14)

As a numeric example for demonstrating the effect of the hinge-point displacement, the following parameters were used:

| | |
|---|---|
| m = 5 mm | Module |
| z₁ = 36 | Number of teeth in basic gear |
| z₂ = 48 | Number of teeth in increased gear |

Without displacement, i.e., when h=0, the circular pitches of the two gears become:
p₁=18.850 mm, p₂=18.853 mm,
   which show a difference of 3μ.

In order to reduce the magnitude of p₂ exactly to the length of p₁, the “h” displacement, calculated by Equation 11 or 12, becomes
h=68.5μ.

With such hinge displacement, p₂ becomes exactly equal to p₁, but at the other intermediate gear sizes, small deviations from p₁ still remain. These deviations, calculated by Equation 14, are shown in FIG. 7 (middle curve). As seen there, the maximum pitch difference only amounts to about 0.75 microns. In contrast, with no hinge displacement (h=0), the deviations of the circular pitch amount to 3 microns, as explained above (upper curve in FIG. 7).

For a comparison, the performance of a tooth-aligned-hinge link is also shown in FIG. 7 (bottom curve). For the tooth-aligned-hinge case the circular pitch in the variable gear is calculated by using Equation 13 as before, with the difference that this time the linear pitch, sᵢ, is kept at the following constant magnitude:

s_{2b}=2R₁ sin(τ₁/2), (15)

where R₁ and τ₁ are given by Equations 3 and 1, respectively.

As seen in the figure, the circular pitch in the tooth-aligned-hinge geometry decreases for increasing gear diameter, and amounts to an overall decrease of 10.5 microns, significantly greater than that of either tooth-centered case.

### Radial Alignment Brackets

Turning now to FIGS. 8-10B, further features of certain preferred embodiments of the present invention will be described. Specifically, in certain preferred embodiments, at least some of links 30 are associated with an aligner arrangement, here implemented as a pair of forked radial alignment brackets 28, which maintains the correct radial alignment of the corresponding tooth 12. FIGS. 8. 10A and 10B show an arrangement of four aligners each associated with links 30 of a corresponding gear tooth assembly. Radial alignment brackets 28 are staggered axially along axle 20 so as to avoid interfering with each other.

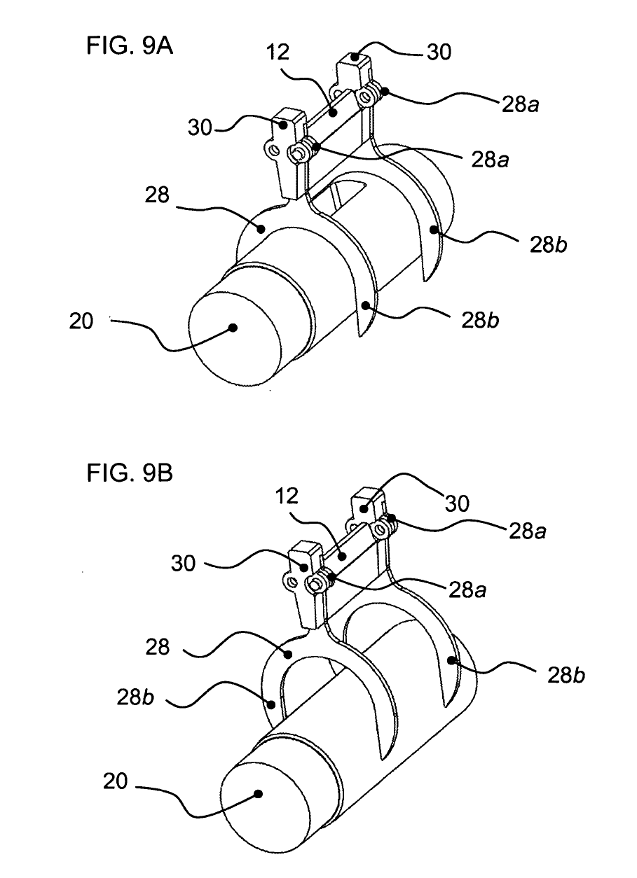

FIGS. 9A and 913 show an individual aligner arrangement in more detail. Specifically, each aligner arrangement includes two radial alignment brackets 28, each of which has a flat shaft portion 28a integrated with the corresponding link 30. According to one possible implementation, each link 30 may be formed as a laminated structure of four or more layers (not shown). This facilitates axial staggering of radial alignment brackets 28 by deploying shaft portion 28a in place of different layers of link 30. A fork portion 28b of each radial alignment bracket 28 is formed with an arcuate crotch shaped to accommodate part of the surface of axle 20 in the minimum diameter state of the variable gear, and has parallel inner surfaces separated by a distance equal to the diameter of axle 20. This allows free rotation on axle 20 and sliding radial motion, such as between the positions of FIGS. 9A and 913, while maintaining radial alignment of shaft portion 28a and hence also of the corresponding gear tooth 12. As mentioned above, the interdependence of the orientation of the teeth also helps to ensure that the intermediate teeth that are not directly supported by an aligner 24 are nevertheless maintained correctly oriented radially relative to the central axle.

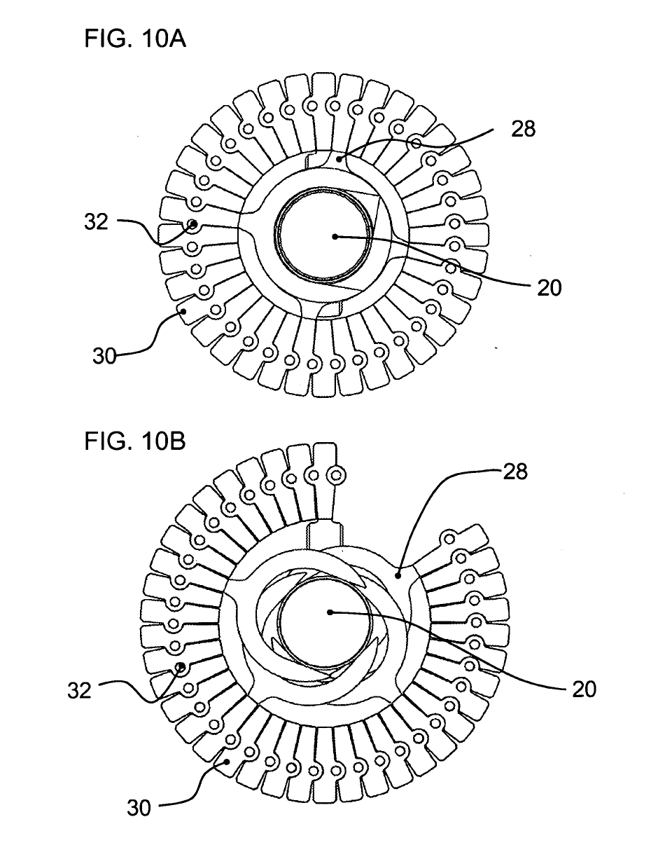

FIGS. 10A and 10B show the minimum diameter state and an expanded diameter state for the full set of four radial alignment brackets 28. Clearly, the number of forked brackets used and their angular distribution can be varied according to the design considerations of any specific application.

Although described herein used in synergy with the tooth-centered link structure of FIGS. 4A-5B, it should be noted that the aligner arrangements described here are also suitable for use with other gear tooth sequence structures, for example, in a tooth-aligned-hinge implementation of a gear tooth sequence such as that illustrated in FIGS. 11A and 11B.

It will be clear that many alternative implementations of the aligner arrangement may be implemented, so long as they provide rotation around the central axle to accommodate the change in angular position of the gear teeth as the diameter varies, and so long as they variations in the radial distance to the teeth as the gear expands and contracts. For example, in some cases, an aligner arrangement may be provided with a telescopic shaft to accommodate the changes in radial distance to the teeth. This and other modifications of the aligner arrangement will be clear to one ordinarily skilled in the art on the basis of this description.

It will be appreciated that the above descriptions are intended only to serve as examples, and that many other embodiments are possible within the scope of the present invention as defined in the appended claims.

What is claimed is:

1. Apparatus for use in a variable ratio transmission, the apparatus comprising:
(a) a plurality of gear teeth formed for engaging a facing gear wheel, each of said teeth having a plane of symmetry parallel to a width of said tooth; and
(b) a plurality of links, each of said links being rigidly associated with a corresponding one of said gear teeth, said links being sequentially interconnected so as to faun hinge joints between adjacent pairs of said plurality of gear teeth, thereby forming a gear tooth sequence,
wherein said hinge joint for each pair of adjacent gear teeth has an axis of rotation lying on a plane bisecting an angle between said planes of symmetry of said adjacent gear teeth.

2. The apparatus of claim 1, wherein said plurality of gear teeth correspond substantially to teeth of an involute gear of given pitch diameter D, and wherein, when said gear teeth are arranged such that said gear tooth sequence approximates to a part of said involute gear of pitch diameter D, said hinge joint for each pair of adjacent gear teeth has an axis of rotation located within one percent of said pitch diameter from a corresponding pitch circle.

3. The apparatus of claim 2, wherein said gear tooth sequence is configured such that, in a minimum diameter state, said gear tooth sequence provides a complete effective gear of pitch diameter D.

4. The apparatus of claim 1, wherein each of said gear teeth is rigidly associated with two of said links, said links being deployed on opposing sides of the corresponding gear tooth.

5. The apparatus of claim 1, further comprising an adjustable support, wherein said gear tooth sequence in engaged by said adjustable support so as to assume a sequence of states including:
(a) a minimum diameter state in which said gear tooth sequence approximates to a part of a gear wheel of pitch radius R₁ and angular pitch between teeth τ₁; and
(b) a maximum diameter state in which said gear tooth sequence approximates to a part of a gear wheel of pitch radius R₂ and angular pitch between teeth τ₂,
wherein a circular pitch between said gear teeth in said maximum diameter state is substantially equal to said circular pitch between said gear teeth in said minimum diameter state.

6. The apparatus of claim 5, wherein said hinge joint for each pair of adjacent teeth is displaced from said pitch circle by an adjustment displacement h defined by:
$$h = \frac{{R}_{1} {τ}_{1}}{24} ( 2 {τ}_{2} - {τ}_{1} ) .$$

7. The apparatus of claim 5, further comprising:
(a) a central axle; and
(b) a plurality of radial alignment brackets, each of said radial alignment brackets being rigidly interconnected with one of said gear teeth, and being engaged with said central axle so as to allow rotation of said radial alignment bracket about said axle and variation of a radial distance of said gear tooth from said axle.
